(19) United States
(12) Patent Application Publication
(10) Pub. No.: US 2019/0106104 A1
(43) Pub. Date: Apr. 11, 2019

(54) DRIVE ASSIST APPARATUS

(71) Applicants: TOYOTA JIDOSHA KABUSHIKI KAISHA, Toyota-shi (JP); NATIONAL UNIVERSITY CORPORATION TOKYO UNIVERSITY OF AGRICULTURE AND TECHNOLOGY, Tokyo (JP); THE UNIVERSITY OF TOKYO, Tokyo (JP); SCHOOL JUDICIAL PERSON IKUTOKU GAKUEN, Atsugi-shi, (JP)

(72) Inventors: Shintaro INOUE, Naka-gun, Kanagawa-ken (JP); Toshiki KINOSHITA, Susono-shi, Shizuoka-ken (JP); Pongsathorn RAKSINCHAROENSAK, Fuchu-shi, Tokyo (JP); Yuichi SAITO, Fuchu-shi, Tokyo (JP); Takuma ITO, Bunkyo-ku, Tokyo (JP); Tsukasa SHIMIZU, Nagakute-shi, Aichi-ken (JP); Hideo INOUE, Atsugi-shi, Kanagawa-ken (JP)

(73) Assignees: TOYOTA JIDOSHA KABUSHIKI KAISHA, Toyota-shi, (JP); NATIONAL UNIVERSITY CORPORATION TOKYO UNIVERSITY O F AGRICULTURE AND TECHNOLOGY, Tokyo (JP); THE UNIVERSITY OF TOKYO, Tokyo (JP); SCHOOL JUDICIAL PERSON IKUTOKU GAKUEN, Atsugi-shi, (JP)

(21) Appl. No.: 16/142,148

(22) Filed: Sep. 26, 2018

(30) Foreign Application Priority Data
Oct. 6, 2017 (JP) 2017-196045

(51) Int. Cl. B60W 30/09; B60W 50/00; B60T 7/12

(52) U.S. Cl. CPC B60W 30/09; B60W 50/0098; B60T 7/12; B60W 2550/148; B60T 2210/12; B60W 2050/0026; B60W 2550/302; B60T 2250/04; B60W 2550/308

(57) ABSTRACT

A drive assist apparatus includes an electronic control unit configured to: compute, when an object that causes a blind spot is ahead of a host vehicle, a first reference velocity which is a velocity at which the host vehicle is able to run without colliding with a moving object assumed to be in the blind spot of the object; estimate a degree of risk associated with a road on which the host vehicle is running, based on environment information that indicates a running environment of the host vehicle; and compute a second reference velocity which is determined by correcting the first reference velocity based on the estimated degree of risk.

### INCORPORATION BY REFERENCE

The disclosure of Japanese Patent Application No. 2017-196045 filed on Oct. 6, 2017 including the specification, drawings and abstract is incorporated herein by reference in its entirety.

### BACKGROUND

### 1. Technical Field

The disclosure relates to a drive assist apparatus.

### 2. Description of Related Art

For example, an apparatus has been suggested as a drive assist apparatus (see Japanese Unexamined Patent Application Publication No. 2009-286279 (JP 2009-286279 A)). The apparatus sets a relative velocity of a host vehicle with respect to a physical object and a lateral movement amount for avoiding the physical object based on the type of the physical object, and controls the host vehicle such that the host vehicle runs so as to achieve the set lateral movement amount.

### SUMMARY

With the technique described in JP 2009-286279 A, the host vehicle is controlled to avoid a physical object recognized by a camera; however, an unobvious risk (in other words, potential risk), such as a pedestrian present in a blind spot of an obstacle, is not taken into consideration.

The disclosure provides a drive assist apparatus that is able to assist driving in consideration of a potential risk.

An aspect of the disclosure provides a drive assist apparatus includes an electronic control unit configured to: compute, when an object that causes a blind spot is ahead of a host vehicle, a first reference velocity which is a velocity at which the host vehicle is able to run without colliding with a moving object assumed to be in the blind spot of the object; estimate a degree of risk associated with a road on which the host vehicle is running, based on environment information that indicates a running environment of the host vehicle; and compute a second reference velocity which is determined by correcting the first reference velocity based on the estimated degree of risk.

### BRIEF DESCRIPTION OF THE DRAWINGS

Features, advantages, and technical and industrial significance of exemplary embodiments of the disclosure will be described below with reference to the accompanying drawings, in which like numerals denote like elements, and wherein:

FIG. 1 is a block diagram that shows the configuration of relevant portions of a vehicle according to an embodiment;

FIG. 2 is a block diagram that shows the configuration of a drive assist system according to the embodiment;

FIG. 3 is a view that shows parameters that are used to calculate a reference velocity according to the embodiment;

FIG. 4A is a first example of a map that defines a reference velocity;

FIG. 4B is a second example of a map that defines a reference velocity;

FIG. 4C is a third example of a map that defines a reference velocity;

FIG. 4D is a fourth example of a map that defines a reference velocity;

FIG. 5A is a view that shows a first example of a risk potential;

FIG. 5B is a view that shows a second example of a risk potential;

FIG. 5C is a view that shows a third example of a risk potential;

FIG. 6 is a timing chart that shows an example of drive assist according to the embodiment;

FIG. 7 is a timing chart that shows another example of drive assist according to the embodiment; and

FIG. 8 is a timing chart that shows another example of drive assist according to the embodiment.

### DETAILED DESCRIPTION OF EMBODIMENTS

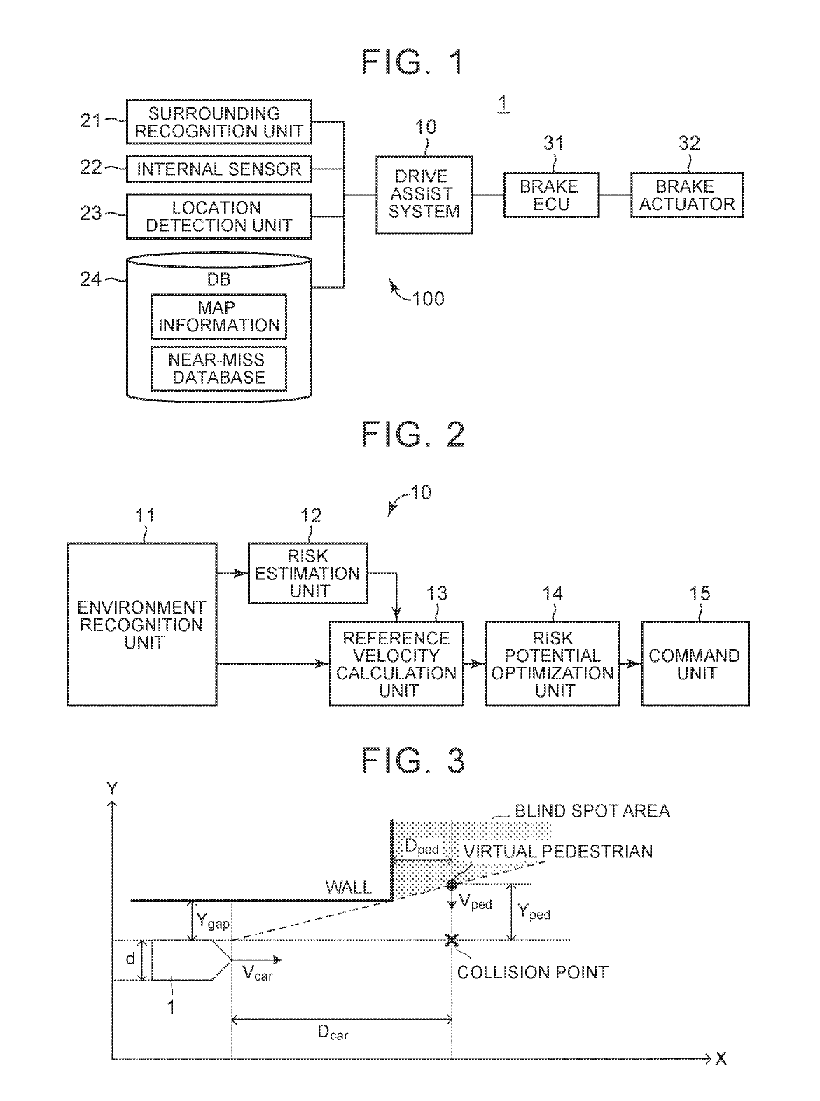

An embodiment of a drive assist apparatus will be described with reference to FIG. 1 to FIG. 8.

### Configuration

The configuration of the drive assist apparatus according to the embodiment will be described with reference to FIG. 1 and FIG. 2. FIG. 1 is a block diagram that shows the configuration of relevant portions of a vehicle according to the embodiment. FIG. 2 is a block diagram that shows the configuration of a drive assist system according to the embodiment.

As shown in FIG. 1, the vehicle 1 including the drive assist apparatus according to the embodiment includes the drive assist system 10, a surrounding recognition unit 21, an internal sensor 22, a location detection unit 23, a database (DB) 24, a brake electronic control unit (ECU) 31, and a brake actuator 32. The drive assist system 10, the surrounding recognition unit 21, the internal sensor 22, the location detection unit 23, and the database 24 constitute the drive assist apparatus 100. The surrounding recognition unit 21, the internal sensor 22, the location detection unit 23, and the database 24 may be shared with other devices (not shown) provided in the vehicle 1.

The surrounding recognition unit 21 includes an external sensor, a rain sensor, and the like. Examples of the external sensor include a camera, radar, and light detection and ranging (LIDAR). The surrounding recognition unit 21 recognizes a surrounding situation based on, for example, signals output from the external sensor and the rain sensor. The surrounding situation includes information about an obstacle (such as a parked vehicle, a pedestrian, and a bicycle) and a structure (such as a wall) around the vehicle 1, and information about the condition of rain.

Examples of the internal sensor 22 include a vehicle speed sensor, an acceleration sensor, a yaw rate sensor, and a steering angle sensor.

The location detection unit 23 includes, for example, a global positioning system (GPS) receiver, a gyro sensor, and the like. The location detection unit 23 detects the location of the vehicle 1 based on radio waves from GPS satellites, received by the GPS receiver, and a signal output from the gyro sensor.

The database 24 stores map information and a near-miss database. The map information includes, for example, information about a road shape (such as a straight road, a curved road, and the number of lanes) and a road structure (such as an elevated road), information about a facility (such as a park and a school), and the like. The near-miss database is constructed based on risk cases, such as traffic accidents. Multiple types of tag information are respectively assigned to pieces of information (that is, near-miss cases) that are contained in the near-miss database.

Specific examples of the tag information include tag information related to a host vehicle motion factor, tag information related to an object, tag information related to a surrounding environment, tag information related to a road shape, and tag information related to map information. The tag information related to a host vehicle motion factor includes, for example, occurrence time and a running status. Examples of the occurrence time include when the host vehicle is running straight ahead, when the host vehicle runs straight into an intersection, when the host vehicle is running straight ahead in an intersection, and when the host vehicle has run straight through an intersection. Examples of the running status include when the host vehicle is running at a constant velocity, when the host vehicle starts moving, when the host vehicle stops, when the host vehicle accelerates, when the host vehicle decelerates, and when the host vehicle is parked. The tag information related to an object includes, for example, an age group, a motion, and a type. Examples of the age group include an elderly person, a middle-aged person, a young person, and a child. Examples of the motion include “human/vehicle running behind the human/on a sidewalk”, “human/vehicle running behind the human/on a side strip”, and “human/vehicle running behind the human/on a roadway”. Examples of the type include “rushing out from a blind spot due to a parked vehicle”, “rushing out from a blind spot due to a passage vehicle”, and “rushing out from a blind spot due to a screen”. The tag information related to a surrounding environment includes, for example, whether there is a traffic light, whether there is a crosswalk, whether there is a stop line, the number of lanes, a time period, a road surface (such as a paved road, an unpaved road, and a railway), a road surface condition (such as a dry condition, a wet condition, and a snow-cover condition), luminosity, passage of people, a traffic volume, a sign, weather, and whether there is a through street. The tag information related to a road shape includes, for example, an intersection shape and a traffic direction. Examples of the intersection shape include a T-intersection, a Y-intersection, a four-road intersection, and a five-road intersection. Examples of the traffic direction include one-way traffic and two-way traffic. The tag information related to map information includes, for example, a school, a university, a restaurant, a movie theater, a library, a bus stop, a station, and an office.

Description of the drive assist system 10 will be added with reference to FIG. 2. In order to execute a drive assist operation, the drive assist system 10 includes an environment recognition unit 11, a risk estimation unit 12, a reference velocity calculation unit 13, a risk potential optimization unit 14, and a command unit 15, as processing blocks logically implemented or physically implemented inside the drive assist system 10.

### Operation of Drive Assist System

The environment recognition unit 11 of the drive assist system 10 acquires a surrounding situation recognized by the surrounding recognition unit 21, a signal (particularly, a velocity of the vehicle 1) output from the internal sensor 22, a location of the vehicle 1, detected by the location detection unit 23, the map information contained in the database 24, and information contained in the near-miss database included in the database 24. The environment recognition unit 11 outputs the acquired surrounding situation, and the like (hereinafter, referred to as recognized environment information where appropriate) to the risk estimation unit 12 and the reference velocity calculation unit 13.

The risk estimation unit 12 estimates a degree of risk associated with movement of the vehicle 1 based on the recognized environment information (details will be described later). The reference velocity calculation unit 13 calculates a reference velocity based on the recognized environment information. The reference velocity is a velocity that the vehicle 1 should take. The reference velocity calculation unit 13 further corrects the reference velocity based on the degree of risk, estimated by the risk estimation unit 12.

### Calculation of Reference Velocity

A method of calculating a reference velocity in the case where the surrounding recognition unit 21 has recognized an object that can cause a blind spot will be described with reference to FIG. 3. FIG. 3 is a view that shows parameters that are used to calculate a reference velocity according to the embodiment. A reference velocity is obtained on the assumption that a virtual moving object (the virtual pedestrian in FIG. 3 is an example of the virtual moving object) rushes out from a blind spot in front of the vehicle 1. It is also assumed that the vehicle 1 and the virtual moving object move straight ahead (in other words, the vehicle 1 and the virtual moving object do not change their directions). A point at which the direction of the vehicle 1 and the direction of the virtual moving object intersect with each other is referred to as collision point (see Collision point in FIG. 3).

In FIG. 3, d denotes the width of the vehicle 1, V_{car} denotes the velocity of the vehicle 1, Y_{gap} denotes a distance between the vehicle 1 and the object (the wall in FIG. 3) that causes the blind spot, and D_{car} denotes a distance from the location of the vehicle 1 (strictly, the front end of the vehicle 1) to the collision point. V_{ped} denotes the velocity of the virtual moving object. D_{ped} denotes a distance between the virtual moving object and the object that causes the blind spot. Y_{ped} denotes a distance from the location of the virtual moving object to the collision point.

The broken line in FIG. 3 indicates the line of sight of a driver of the vehicle 1. In FIG. 3, the location of the virtual moving object, indicated by black circle, is a location at which the virtual moving object is recognized by the driver of the vehicle 1 for the first time (that is, a location at which the virtual moving object exits from the blind spot caused by the wall and enters the view of the driver of the vehicle 1 for the first time).

The reference velocity means a velocity at which the vehicle 1 is able to avoid a collision with the virtual moving object in the situation shown in FIG. 3 when the driver of the vehicle 1 recognizes the virtual moving object and then applies sudden braking or when the virtual moving object is recognized by the vehicle 1 and then collision mitigation braking is activated.

A method of calculating a reference velocity will be specifically described. Initially, the relation between Y_{gap} and Y_{ped} is expressed by the following mathematical expression (1). The variable t denotes time.

$${Y}_{ped} ( t ) = \frac{{D}_{car} ( t )}{( {D}_{car} ( t ) - {D}_{ped} )} {Y}_{gap} \qquad ( 1 )$$

A time required for the vehicle 1 to reach the collision point is expressed by the following mathematical expression (2).

$${T}_{tc \_ car} ( t ) = \frac{{D}_{car} ( t )}{{V}_{car} ( t )} \qquad ( 2 )$$

A time required for the virtual moving object to reach the collision point is expressed by the following mathematical expression (3).

$${T}_{tc \_ ped} ( t ) = \frac{{Y}_{ped} ( t )}{{V}_{ped} ( t )} \qquad ( 3 )$$

When the vehicle 1 and the virtual moving object collide with each other, T_{tc}_{_}_{car}=T_{tc}_{_}_{ped}, so the mathematical expression D_{car}(t)/V_{car}(t)=Y_{ped}(t)/V_{ped}(t) is obtained from the mathematical expression (2) and the mathematical expression (3). From this mathematical expression and the mathematical expression (1), D_{car}(t)/V_{car}(t) is expressed by the following mathematical expression (4).

$$\frac{{D}_{car} ( t )}{{V}_{car} ( t )} = \frac{( \frac{{D}_{car} ( t )}{{D}_{car} ( t ) - {D}_{ped}} ) \cdot {Y}_{gap}}{{V}_{ped} ( t )} \qquad ( 4 )$$

The mathematical expression (4) expresses the condition that the vehicle 1 and the virtual moving object collide with each other. The value of D_{car}(t) at time at which the mathematical expression (4) is satisfied, that is, time at which the condition that the vehicle 1 and the virtual moving object collide with each other is satisfied, is denoted by D_{car}. In order to avoid a collision between the vehicle 1 and the virtual moving object, it is assumed that, at the location at which a distance from the vehicle 1 to the collision point is D_{car} (that is, in the situation shown in FIG. 3), the virtual moving object is recognized and braking force is applied to the vehicle 1. A duration from when the virtual moving object is recognized until braking force is actually applied to the vehicle 1 (that is, a response time or a recognition time) is denoted by τ, and a maximum deceleration caused by braking force is denoted by aₘₐₓ. At this time, a stop distance Dₛₜₒₚ of the vehicle 1 is expressed by the following mathematical expression (5).

$${D}_{stop} = {V}_{car} \cdot τ + \frac{{V}_{car}^{2}}{2 {a}_{max}} \qquad ( 5 )$$

The stop distance Dₛₜₒₚ is, for example, a distance from a point at which the vehicle 1 recognizes the virtual moving object and decelerates at the maximum deceleration aₘₐₓ to a point at which the vehicle 1 stops. The maximum deceleration aₘₐₓ is, for example, an acceleration of the vehicle 1 when the vehicle 1 is decelerated by maximum braking force that can be applied to the vehicle 1.

When the stop distance Dₛₜₒₚ is shorter than or equal to D_{car}, the vehicle 1 is able to avoid a collision with the virtual moving object. For this reason, the maximum value of the velocity V_{car} that the vehicle 1 can take to avoid a collision with the virtual moving object is a velocity in the case where the stop distance Dₛₜₒₚ is D_{car}. Therefore, the maximum value of the velocity V_{car} that the vehicle 1 can take is expressed by the following mathematical expression (6) by substituting D_{car} into the stop distance Dₛₜₒₚ of the mathematical expression (5). The velocity V_{car} that is expressed by the mathematical expression (6) corresponds to an example of the reference velocity.

$${V}_{car} = {a}_{max} ( - τ + \sqrt{{τ}^{2} + \frac{2 {D}_{car}}{{a}_{max}}} ) \qquad ( 6 )$$

Incidentally, V_{ped} and D_{ped} related to the virtual moving object in the mathematical expression (4) are values that vary depending on the virtual moving object. As a result, D_{car} varies with D_{ped}. τ and aₘₐₓ in the mathematical expression (6) are values that vary depending on the driver of the vehicle 1 and the specifications of a brake device. For this reason, when a reference velocity is determined, the values of V_{ped}, D_{ped}, τ, and aₘₐₓ are tentatively set. On the other hand, Y_{gap} in the mathematical expression (4) is measurable by using, for example, the environment recognition unit 11.

In theory, a reference velocity is obtained by, for example, tentatively setting the values of V_{ped}, D_{ped}, τ, and aₘₐₓ variously and then selecting a presumably appropriate reference velocity from among a plurality of candidate reference velocities. However, it is not realistic when a practical processing load is taken into consideration. In the present embodiment, a reference velocity is obtained from a map that defines the relation between measurable Y_{gap} and a reference velocity.

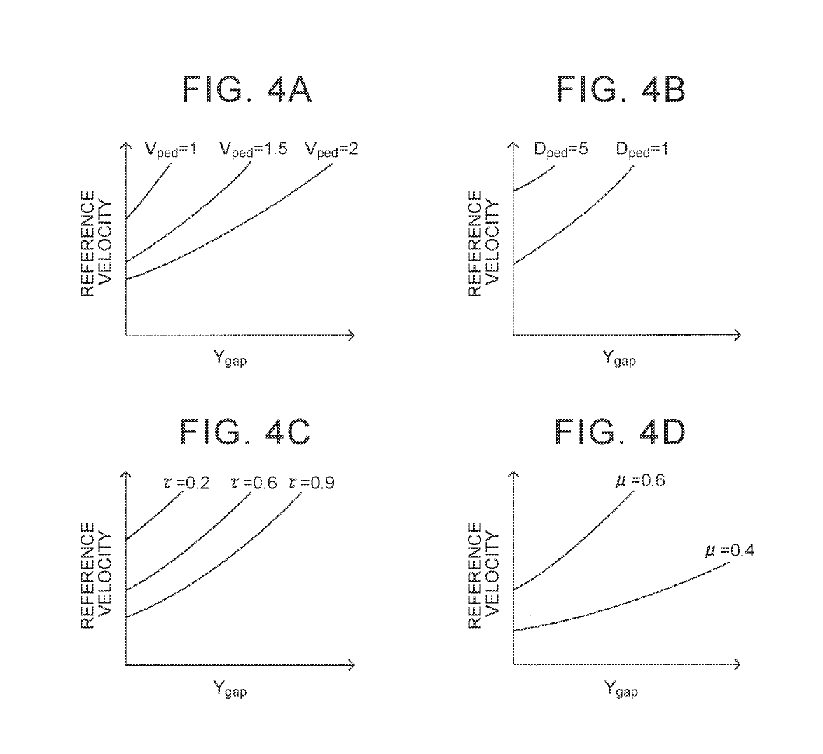

Examples of the map will be described with reference to FIG. 4A to FIG. 4D. FIG. 4A is an example of a map that defines the relation between Y_{gap} and a reference velocity in the case where V_{ped} is varied while D_{ped}, τ, and aₘₐₓ are set to constant values (fixed values). As is apparent from FIG. 4A, when Y_{gap} is constant, the reference velocity decreases as V_{ped} increases. FIG. 4B is an example of a map that defines the relation between Y_{gap} and a reference velocity in the case where D_{ped} is varied while V_{ped}, τ, and aₘₐₓ are set to constant values (fixed values). As is apparent from FIG. 4B, when Y_{gap} is constant, the reference velocity decreases as D_{ped} reduces.

FIG. 4C is an example of a map that defines the relation between Y_{gap} and a reference velocity in the case where τ is varied while V_{ped}, D_{ped}, and aₘₐₓ are set to constant values (fixed values). As is apparent from FIG. 4C, when Y_{gap} is constant, the reference velocity decreases as τ (in other words, free running distance) increases. The maximum deceleration aₘₐₓ of the vehicle 1 is expressed by aₘₐₓ=μg when a road surface friction coefficient is denoted by μ. g is a gravitational acceleration. FIG. 4D is an example of a map that defines the relation between Y_{gap} and a reference velocity in the case where μ, is varied while V_{ped}, D_{ped}, and τ are set to constant values (fixed values). As is apparent from FIG. 4D, when Y_{gap} is constant, the reference velocity decreases as μ reduces (in other words, as a braking distance extends).

The reference velocity calculation unit 13 has a plurality of maps corresponding to various combinations of V_{ped}, D_{ped}, t, and aₘₐₓ (or μ) (that is, maps that define the relation between Y_{gap} and a reference velocity). The reference velocity calculation unit 13 selects one map from among the plurality of maps based on recognized environment information, and calculates a reference velocity based on the selected map and Y_{gap} that is obtained from the recognized environment information.

Selection of a map will be described by way of specific examples. For example, when a crosswalk is ahead of the vehicle 1 in a residential street around noon on a sunny day, D_{ped} is tentatively set to a distance from an object that causes a blind spot to the center of the crosswalk in the width direction, V_{ped} is tentatively set to one meter per second, t is tentatively set to 0.7 seconds, and μ is tentatively set to 0.8. The reference velocity calculation unit 13 selects one map appropriate for the tentatively set values. The condition that “in a residential street around noon” may be set based on, for example, time that is indicated by a system clock, the current location of the vehicle 1, and map information. Both the current location of the vehicle 1 and the map information are included in the recognized environment information. The road surface friction coefficient μ may be actually measured with an existing technique.

For example, when an intersection with no crosswalk is ahead of the vehicle 1, D_{ped} may be tentatively set to, for example, a distance from an object that causes a blind spot to the center of a road in the width direction, the road intersecting with a road on which the vehicle 1 is running. For example, when a school is near a road on which the vehicle 1 is running and the vehicle 1 is running in a time period for going to or from school, a child can possibly rush out, so V_{ped} may be tentatively set to five meters per second, or the like. For example, when a road surface is wet due to rain, or the like, μ may be tentatively set to 0.5, or the like. For example, when the rain is so heavy that the view of the driver of the vehicle 1 deteriorates, τ may be tentatively set to 0.9 seconds, or the like, and μ may be tentatively set to 0.4, or the like.

When there are two or more combinations of V_{ped}, D_{ped}, τ, and aₘₐₓ (or μ), for example, when both a pedestrian and a bicycle are assumed as virtual moving objects, the reference velocity calculation unit 13 may select two or more maps from among the plurality of maps. In this case, the reference velocity calculation unit 13 selects the lowest reference velocity from among the two or more reference velocities respectively obtained from the selected two or more maps.

As described above, the reference velocity calculation unit 13 is able to obtain a reference velocity at a point that is D_{car} before a collision point based on actually measurable information Y_{gap} (furthermore, μ), tentatively set information D_{ped} and V_{ped} related to the virtual moving object, and tentatively set information τ and aₘₐₓ related to braking of the vehicle 1. The obtained reference velocity is a velocity at which the vehicle 1 is able to avoid a collision with a moving object even when the moving object actually rushes out.

### Estimation of Degree of Risk

A method of estimating a degree of risk will be described. In the present embodiment, the case where the degree of risk is estimated at three levels, that is, high, medium, and low, will be described as an example. However, the degree of risk is not limited to three levels; the degree of risk may be estimated at four or more levels or two levels.

The risk estimation unit 12 (see FIG. 2) estimates a degree of risk associated with a road on which the vehicle 1 is running, based on recognized environment information (particularly, based on the map information and the near-miss database). More specifically, the risk estimation unit 12 estimates a road environment of a road on which the vehicle 1 is running, based on the map information. The road environment means information that is able to be read from the map information. Examples of the information include a road shape, a road type, whether there is a crosswalk or a traffic light, and whether there is a sidewalk or a side strip. The risk estimation unit 12 estimates a traffic environment of a road on which the vehicle 1 is running, based on the recognized environment information. The traffic environment means information related to one that can possibly influence movement of the vehicle 1. Examples of the information include travel time (or a travel time period), a road surface condition, whether a traffic volume is large or small, whether there is a parked vehicle, whether passage of people is large or small, and whether there is a facility that causes passage of people, such as a park and a school.

The risk estimation unit 12 also extracts one or more pieces of information (that is, near-miss case(s)), corresponding to the estimated road environment and traffic environment, based on the pieces of tag information respectively assigned to the pieces of information contained in the near-miss database. The risk estimation unit 12 estimates a degree of risk by totally considering the estimated road environment and traffic environment and the extracted one or more pieces of information.

For example, when the vehicle 1 is running on a community road in a time period for going to or from school, the risk estimation unit 12 estimates that the degree of risk is high (in this case, it is presumable that there is a relatively high possibility of rushing out of a child who goes to or from school). Alternatively, for example, when the vehicle 1 is running on a community road in a time period in the daytime on a weekday, the risk estimation unit 12 estimates that the degree of risk is medium (in this case, people go out for shopping and lunch and there is a relatively high possibility of rushing out of mainly an adult). Alternatively, for example, when the vehicle 1 is running on a road that is not a community road at midnight, the risk estimation unit 12 estimates that the degree of risk is low (in this case, there is a relatively low possibility of rushing out of a pedestrian or bicycle).

### Correction of Reference Velocity

The reference velocity calculation unit 13 corrects the reference velocity based on the degree of risk, estimated by the risk estimation unit 12. Specifically, the reference velocity calculation unit 13 corrects the reference velocity by adding a velocity correction amount commensurate with the degree of risk to the reference velocity. The reference velocity calculation unit 13 typically corrects the reference velocity such that a corrected reference velocity decreases as a degree of risk increases.

Here, the velocity correction amount is denoted by w, the reference velocity is denoted by Vₘᵢₙ, the corrected reference velocity is denoted by V′ₘᵢₙ, and the initial velocity of the vehicle 1 is denoted by V₀. The initial velocity V₀ is a velocity before the vehicle 1 is decelerated to bring the velocity of the vehicle 1 to the reference velocity Vₘᵢₙ.

When the degree of risk is high, the velocity correction amount w is zero. Therefore, V′ₘᵢₙ=Vₘᵢₙ. When the degree of risk is medium, the velocity correction amount w is obtained by the mathematical expression w=(V₀−Vₘᵢₙ)/3. In this case, the corrected reference velocity V′ₘᵢₙ is obtained by the mathematical expression V′ₘᵢₙ=Vₘᵢₙ+w=Vₘᵢₙ+(V₀−Vₘᵢₙ)/3. When the degree of risk is low, the velocity correction amount w is obtained by the mathematical expression w=2(V₀−Vₘᵢₙ)/3. In this case, the corrected reference velocity V′ₘᵢₙ is obtained by the mathematical expression V′ₘᵢₙ=Vₘᵢₙ+2(V₀−Vₘᵢₙ)/3. That is, the velocity correction amount w is expressed by the product of a variable that varies with the degree of risk (zero (degree of risk: high), ⅓ (degree of risk: medium), ⅔ (degree of risk: low)) and V₀−Vₘᵢₙ.

### Optimization of Risk Potential

Initially, a risk potential is expressed by the following mathematical expression (7). The risk potential indicates, for example, a possibility that an accident occurs around the vehicle 1. In the mathematical expression (7), Uᵣᵢₛₖ denotes a risk potential, k_{ped} denotes a spring constant, Xₑ denotes a location of the vehicle 1 in an X-axis direction, and Xₛₜ denotes an initial location of the vehicle 1.

Uᵣᵢₛₖ=½k_{ped}(Xₑ−Xₛₜ)² (7)

The above-described corrected reference velocity V′ₘᵢₙ is reflected by the spring constant k_{ped}. Specifically, the spring constant k_{ped} is expressed by the following mathematical expression (8). In the mathematical expression (8), m denotes the mass of the vehicle 1, lₘₐₓ, denotes a distance from a collision point (see FIG. 3) to a location at which application of braking force to the vehicle 1 is started in order to bring the velocity of the vehicle 1 to the corrected reference velocity V′ₘᵢₙ, and l(t) denotes a distance from the collision point to the vehicle 1.

$${k}_{ped} = \frac{m ( {( {V}_{min}^{′} )}^{2} - {{V}_{car} ( t )}^{2} )}{{[ {l}_{max} - l ( t ) ]}^{2} - {[ {l}_{max} + {D}_{ped} - {D}_{car} ]}^{2}} \qquad ( 8 )$$

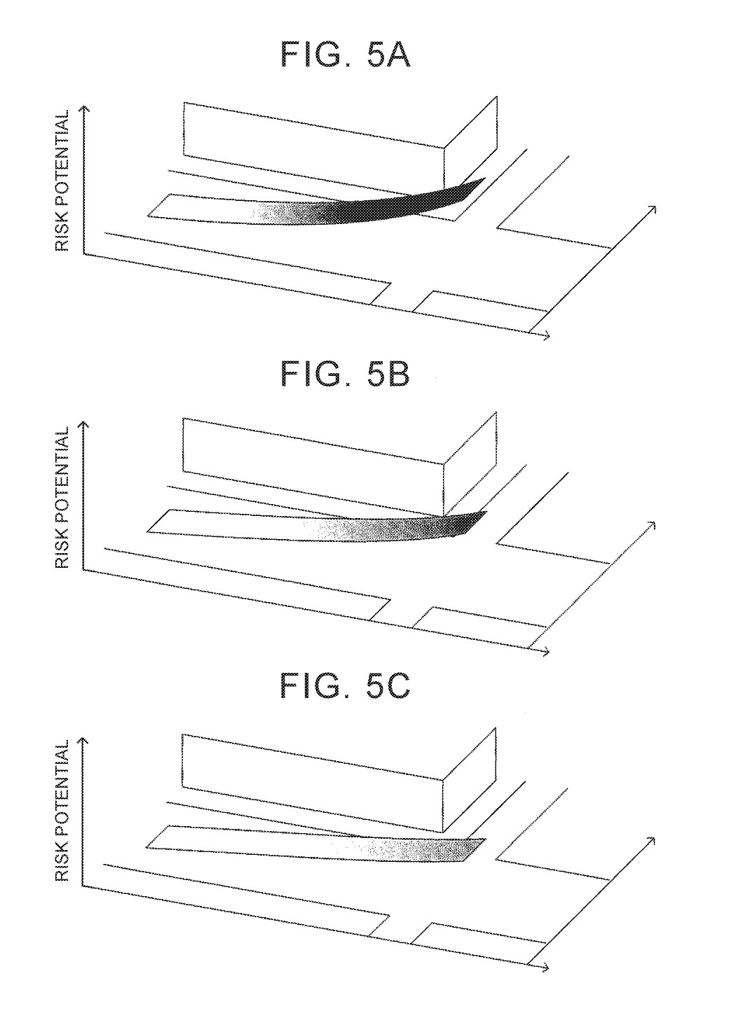

The risk potential optimization unit 14 (see FIG. 2) optimizes the risk potential associated with the vehicle 1 with the use of the mathematical expressions (7) and (8). FIG. 5A to FIG. 5C show examples of the optimized risk potential. Initially, when a running road is a community road and a running time period is time to go to or from school, the degree of risk is high. As shown in FIG. 5A, when the degree of risk is high, the risk potential becomes relatively large near the intersection. On the other hand, when a running road is not a community road and a running time period is midnight, the degree of risk is low. When the degree of risk is low, the risk potential does not significantly vary, as shown in FIG. 5C. When a running road is a community road and a running time period is daytime (such as between time to go to school and time to go from school), the degree of risk is medium. When the degree of risk is medium, the risk potential is medium between the risk potential shown in FIG. 5A and the risk potential shown in FIG. 5C, as shown in FIG. 5B.

### Brake Control

The command unit 15 (see FIG. 2) calculates a command value to be output to the brake ECU 31 (see FIG. 1) based on the risk potential optimized by the risk potential optimization unit 14. The command unit 15 obtains braking force to be applied to the vehicle 1 and calculates a command value, based on a potential method (that is, a method that uses a potential field). As a result, the brake actuator 32 is controlled by the brake ECU 31, and the velocity of the vehicle 1 is automatically decelerated to the corrected reference velocity V′ₘᵢₙ. An existing technique is applicable to a method of calculating a command value with the potential method, so the detailed description thereof is omitted.

### Example of Operation of Vehicle

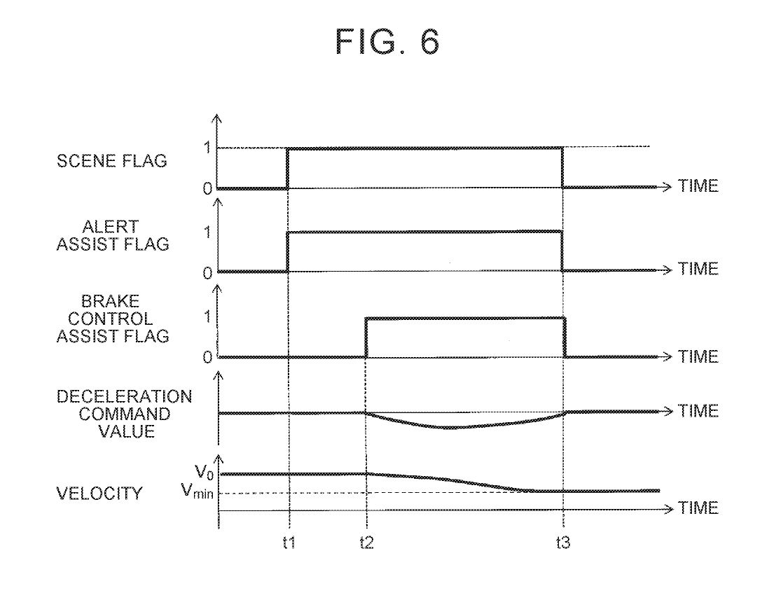

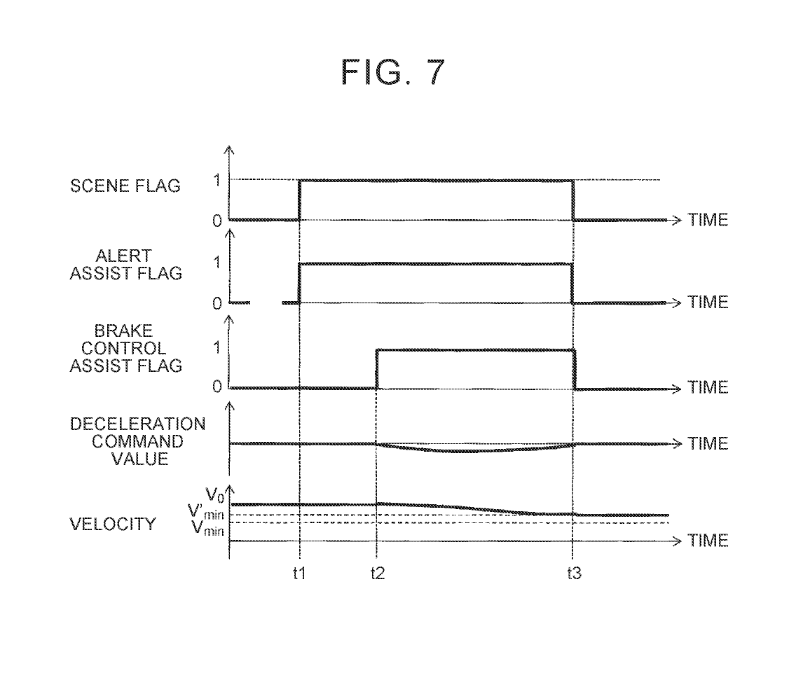

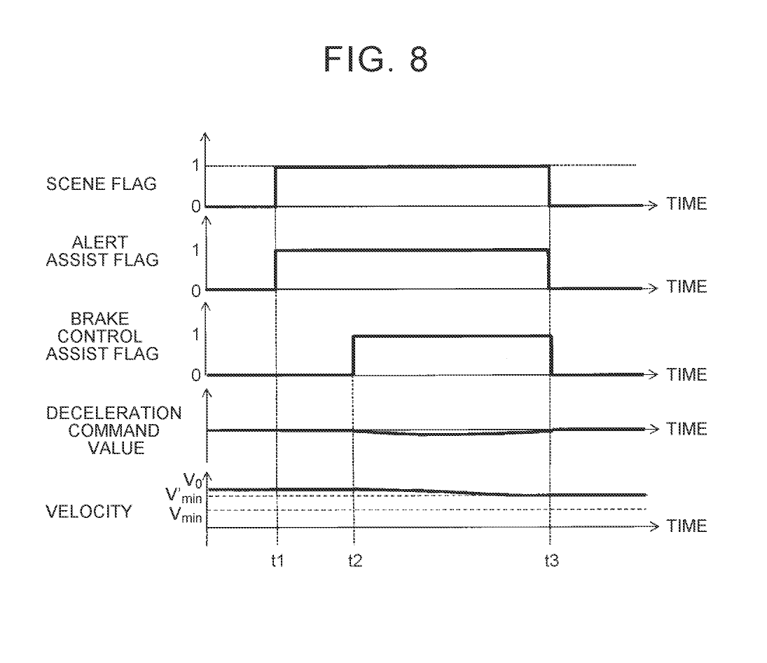

Next, a specific example of the operation of the vehicle 1 by the action of the drive assist apparatus 100 configured as described above will be described with reference to the timing charts of FIG. 6 to FIG. 8. Descriptions of FIG. 7 and FIG. 8, which overlap with a description of FIG. 6, are omitted.

### Degree of Risk: High

At time t1 of FIG. 6, for example, as a parked vehicle has been detected ahead of the vehicle 1 or as an intersection has been detected ahead of the vehicle 1, a scene flag is set to an on state (that is, 1). The scene flag indicates whether driving is assisted by the drive assist system 10. In addition, a flag related to alert assist, that is, an alert assist flag, is also set to an on state (that is, 1). The alert assist alerts the driver of the vehicle 1 with voice or text. An existing technique is applicable for alert assist, so the detailed description thereof is omitted.

After the scene flag is set to the on state at time t1, the degree of risk is estimated by the risk estimation unit 12 (here, it is assumed that the degree of risk is high). A reference velocity Vₘᵢₙ is calculated by the reference velocity calculation unit 13, and the calculated reference velocity Vₘᵢₙ is corrected by the velocity correction amount w commensurate with the degree of risk. Since the degree of risk is high, w=0, and the reference velocity Vₘᵢₙ is equal to the corrected reference velocity.

After that, the risk potential is optimized by the risk potential optimization unit 14, and a command value is output from the command unit 15 to the brake ECU 31. As the command value (deceleration command value in FIG. 6) is output from the command unit 15 at time t2 of FIG. 6, a brake control assist flag is set to an on state (that is, 1). As a result, braking force is applied to the vehicle 1, and the velocity of the vehicle 1 becomes the reference velocity Vₘᵢₙ at time t3.

As the velocity of the vehicle 1 becomes the reference velocity Vₘᵢₙ, the scene flag, the alert assist flag, and the brake control assist flag each are set to an off state (that is, 0). The location of the vehicle 1 at time t2 of FIG. 6 is a location that is lₘₐₓ (see the mathematical expression (8)) before the collision point (see FIG. 3). The location of the vehicle 1 at time t3 of FIG. 6 is a location that is D_{car} before the collision point.

### Degree of Risk: Medium

In FIG. 7, the degree of risk is estimated to be medium by the risk estimation unit 12. In this case, the velocity correction amount w is expressed by the mathematical expression w=(V₀−Vₘᵢₙ)/3. The reference velocity calculation unit 13 sets a value, obtained by adding the velocity correction amount w to the reference velocity Vₘᵢₙ, for the corrected reference velocity V′ₘᵢₙ. In this case, the corrected reference velocity V′ₘᵢₙ is a value higher by (V₀−Vₘᵢₙ)/3 than the reference velocity Vₘᵢₙ. As a command value is output from the command unit 15 at time t2 of FIG. 7, braking force is applied to the vehicle 1, and the velocity of the vehicle 1 becomes the reference velocity V′ₘᵢₙ at time t3.

### Degree of Risk: Low

In FIG. 8, the degree of risk is estimated to be low by the risk estimation unit 12. In this case, the velocity correction amount w is expressed by the mathematical expression w=2(V₀−Vₘᵢₙ)/3. The reference velocity calculation unit 13 sets a value, obtained by adding the velocity correction amount w to the reference velocity Vₘᵢₙ, for the corrected reference velocity V′ₘᵢₙ. In this case, the corrected reference velocity V′ₘᵢₙ is a value higher by 2(V₀−Vₘᵢₙ)/3 than the reference velocity Vₘᵢₙ. As a command value is output from the command unit 15 at time t2 of FIG. 8, braking force is applied to the vehicle 1, and the velocity of the vehicle 1 becomes the reference velocity V′ₘᵢₙ at time t3.

### Technical Advantageous Effects

In the drive assist apparatus 100, a reference velocity Vₘᵢₙ is calculated based on recognized environment information. The reference velocity Vₘᵢₙ is a velocity at which the vehicle 1 is able to avoid a collision with a virtual moving object in the case where a distance between the vehicle 1 and a collision point is D_{car} (see FIG. 3). A degree of risk is estimated based on the recognized environment information, and the reference velocity Vₘᵢₙ is corrected based on the estimated degree of risk. Brake control is executed such that the velocity of the vehicle 1 becomes the corrected reference velocity V′ₘᵢₙ. Therefore, with the drive assist apparatus 100, it is possible to assist driving in consideration of a potential risk (that is, the virtual moving object).

In the drive assist apparatus 100, particularly, the reference velocity Vₘᵢₙ is corrected based on the estimated degree of risk. Specifically, as the estimated degree of risk decreases, the reference velocity Vₘᵢₙ is corrected so as to increase. Therefore, with brake control that is executed by the drive assist apparatus 100, it is possible to reduce undue deceleration of the vehicle 1.

### Alternative Embodiment

In the above-described embodiment, a degree of risk is estimated by the risk estimation unit 12. Alternatively, the drive assist system 10 of the drive assist apparatus 100 does not need to include the risk estimation unit 12 (that is, a reference velocity calculated by the reference velocity calculation unit 13 does not need to be corrected). With such a configuration as well, it is possible to assist driving in consideration of a potential risk.

Various aspects that are derived from the embodiment and alternative embodiment described above will be described below.

A drive assist apparatus according to an aspect of the disclosure includes an electronic control unit configured to: compute, when an object that causes a blind spot is ahead of a host vehicle, a first reference velocity which is a velocity at which the host vehicle is able to run without colliding with a moving object assumed to be in the blind spot of the object; estimate a degree of risk associated with a road on which the host vehicle is running, based on environment information that indicates a running environment of the host vehicle; and compute a second reference velocity which is determined by correcting the first reference velocity based on the estimated degree of risk.

With the drive assist apparatus, a reference velocity is obtained in consideration of a virtual moving object. By assisting driving based on the reference velocity, the drive assist apparatus is able to assist driving in consideration of a potential risk (that is, the virtual moving object). In the drive assist apparatus, the reference velocity is corrected based on, particularly, a degree of risk associated with a road on which the host vehicle is running. As a result, in comparison with the case where a reference velocity is not corrected based on a degree of risk, it is possible to obtain a reference velocity further suitable for a road on which the host vehicle is running.

Examples of the environment information include (i) information that is able to be read from map information, such as the shape and type of a road, whether there is a crosswalk or a traffic light, and whether there is a sidewalk or a side strip, (ii) information related to one that can possibly influence running of the host vehicle, such as travel time (or a travel time period), a road surface condition, whether a traffic volume is large or small, whether there is a parked vehicle, whether passage of people is large or small, and whether there is a facility that causes passage of people, such as a park and a school, and (iii) weather information. The reference velocity calculation unit 13 of the above described embodiment may compute the first reference velocity and the second reference velocity. Furthermore, the risk estimation unit 12 of the above described embodiment may estimate the degree of risk associated with the road on which the host vehicle is running.

In the above-described aspect of the drive assist apparatus, the electronic control unit may be configured to compute the second reference velocity by adding, to the first reference velocity, a product of a difference between a velocity of the host vehicle and the first reference velocity and a coefficient that varies with the estimated degree of risk. According to this aspect, it is possible to relatively easily correct a reference velocity in accordance with a degree of risk. The velocity of the host vehicle typically means a velocity of the host vehicle at the time when a reference velocity is obtained by the drive assist apparatus. V₀ in the above-described embodiment corresponds to an example of the velocity of the host vehicle. According to this aspect, it is possible to calculate a further appropriate reference velocity.

In another aspect of the above-described drive assist apparatus, the electronic control unit may be configured to compute the first reference velocity based on (i) a velocity of the host vehicle, (ii) a velocity of the moving object, (iii) a first distance that is a distance between the host vehicle and the moving object in a traveling direction of the host vehicle, (iv) a second distance that is a distance between the moving object and the object in the traveling direction, (v) a third distance that is a distance between the host vehicle and the object in a direction that intersects with the traveling direction, and (vi) a stop distance that is a shortest distance which the host vehicle running at the velocity of the host vehicle requires to stop.

According to this aspect, it is possible to relatively easily compute a reference velocity commensurate with the first distance. The reference velocity commensurate with the first distance means that the reference velocity varies with the first distance. Specifically, as the first distance (that is, the distance between the host vehicle and the virtual moving object) reduces, the reference velocity decreases. This is because it is not possible to avoid a collision between the host vehicle and the virtual moving object unless the stop distance of the host vehicle is reduced as the first distance reduces. D_{car}, D_{ped}, and Y_{gap} in the above-described embodiment respectively correspond to examples of the first distance, second distance and third distance.

In this aspect, at least one of the velocity of the moving object, the second distance, a response time that determines the stop distance, and a road surface friction coefficient that determines the stop distance may be set in accordance with the environment information, the response time being a time from when the host vehicle recognizes the moving object until automatic braking is activated, the road surface friction coefficient being a friction coefficient that determines friction force that acts between each tire of the host vehicle and a road surface. With such a configuration, it is possible to calculate a reference velocity appropriate for a running environment of the host vehicle.

In this aspect, the drive assist apparatus may further include a detection device configured to detect a third distance that is a distance between the host vehicle and the object in a direction that intersects with a traveling direction of the host vehicle, wherein the electronic control unit may be configured to: store a plurality of maps corresponding to values of a velocity of the moving object, a second distance that is a distance between the moving object and the object in the traveling direction, a response time from when the host vehicle recognizes the moving object until automatic braking is activated, and a road surface friction coefficient that determines friction force that acts between each tire of the host vehicle and a road surface, and the map defining a relation between the third distance and the first reference velocity; and compute the first reference velocity based on the third distance detected by the detection device and one of the plurality of maps. With such a configuration, it is possible to compute a reference velocity while reducing a processing load on the drive assist apparatus. In the above-described embodiment, the environment recognition unit 11 corresponds to an example of the detection device.

In this aspect, the electronic control unit may be further configured to control the host vehicle such that a velocity of the host vehicle running at a first velocity becomes the second reference velocity at the time when a first distance becomes a stop distance, the first distance being a distance between the host vehicle and the moving object in a traveling direction of the host vehicle, the stop distance being a shortest distance which the host vehicle running at the first velocity requires to stop. With such a configuration, it is possible to relatively easily bring the speed of the host vehicle to the reference velocity. The command unit 15 of the above described embodiment may control the host vehicle.

A drive assist apparatus according to a second aspect of the disclosure includes an electronic control unit configured to: compute, when an object that causes a blind spot is ahead of a host vehicle, a first reference velocity which is a velocity at which the host vehicle is able to run without colliding with a moving object assumed to be in the blind spot of the object, based on (i) a velocity of the host vehicle, (ii) a velocity of the moving object, (iii) a first distance that is a distance between the host vehicle and the moving object in a traveling direction of the host vehicle, (iv) a second distance that is a distance between the moving object and the object in the traveling direction, (v) a third distance that is a distance between the host vehicle and the object in a direction that intersects with the traveling direction, and (vi) a stop distance that is a shortest distance which the host vehicle running at the velocity of the host vehicle requires to stop; estimate a degree of risk associated with a road on which the host vehicle is running, based on environment information that indicates a running environment of the host vehicle; and compute a second reference velocity which is determined by correcting the first reference velocity based on the estimated degree of risk. With the drive assist apparatus, a reference velocity is obtained in consideration of a virtual moving object. By assisting driving based on the reference velocity, the drive assist apparatus is able to assist driving in consideration of a potential risk.

In an aspect of the above-described drive assist apparatus, at least one of the velocity of the moving object, the second distance, a response time that determines the stop distance, and a road surface friction coefficient that determines the stop distance may be set in accordance with the environment information. According to this aspect, it is possible to calculate a reference velocity appropriate for a running environment of the host vehicle.

A drive assist apparatus according to a third aspect of the disclosure includes a detection device configured to detect a third distance that is a distance between a host vehicle and an object that causes a blind spot is ahead of a host vehicle, in a direction that intersects with a traveling direction of the host vehicle; and an electronic control unit configured to store a plurality of maps corresponding to values of a velocity of the moving object, a second distance that is a distance between the moving object and the object in the traveling direction, a response time from when the host vehicle recognizes the moving object until automatic braking is activated, and a road surface friction coefficient that determines friction force that acts between each tire of the host vehicle and a road surface, and the map defining a relation between the third distance and the first reference velocity, compute a first reference velocity which is a velocity at which the host vehicle is able to run without colliding with a moving object assumed to be in the blind spot of the object based on the third distance detected by the detection device and one of the plurality of maps when the object is ahead of a host vehicle, estimate a degree of risk associated with a road on which the host vehicle is running based on environment information that indicates a running environment of the host vehicle, and compute a second reference velocity which is determined by correcting the first reference velocity based on the estimated degree of risk. According to this aspect, it is possible to compute a reference velocity while reducing a processing load on the drive assist apparatus.

The disclosure is not limited to the above-described embodiments. The disclosure may be modified as needed without departing from the scope or concept of the disclosure, which read from the appended claims and the overall specification. The technical scope of the disclosure also encompasses drive assist apparatuses that include such modifications.

What is claimed is:

1. A drive assist apparatus comprising an electronic control unit configured to:
compute, when an object that causes a blind spot is ahead of a host vehicle, a first reference velocity which is a velocity at which the host vehicle is able to run without colliding with a moving object assumed to be in the blind spot of the object;
estimate a degree of risk associated with a road on which the host vehicle is running, based on environment information that indicates a running environment of the host vehicle; and
compute a second reference velocity which is determined by correcting the first reference velocity based on the estimated degree of risk.

2. The drive assist apparatus according to claim 1, wherein the electronic control unit is configured to compute the second reference velocity by adding, to the first reference velocity, a product of a difference between a velocity of the host vehicle and the first reference velocity and a coefficient that varies with the estimated degree of risk.

3. The drive assist apparatus according to claim 1, wherein the electronic control unit is configured to compute the first reference velocity based on (i) a velocity of the host vehicle, (ii) a velocity of the moving object, (iii) a first distance that is a distance between the host vehicle and the moving object in a traveling direction of the host vehicle, (iv) a second distance that is a distance between the moving object and the object in the traveling direction, (v) a third distance that is a distance between the host vehicle and the object in a direction that intersects with the traveling direction, and (vi) a stop distance that is a shortest distance which the host vehicle running at the velocity of the host vehicle requires to stop.

4. The drive assist apparatus according to claim 3, wherein at least one of the velocity of the moving object, the second distance, a response time that determines the stop distance, and a road surface friction coefficient that determines the stop distance is set in accordance with the environment information, the response time being a time from when the host vehicle recognizes the moving object until automatic braking is activated, the road surface friction coefficient being a friction coefficient that determines friction force that acts between each tire of the host vehicle and a road surface.

5. The drive assist apparatus according to claim 1, further comprising a detection device configured to detect a third distance that is a distance between the host vehicle and the object in a direction that intersects with a traveling direction of the host vehicle, wherein the electronic control unit is configured to:
store a plurality of maps corresponding to values of a velocity of the moving object, a second distance that is a distance between the moving object and the object in the traveling direction, a response time from when the host vehicle recognizes the moving object until automatic braking is activated, and a road surface friction coefficient that determines friction force that acts between each tire of the host vehicle and a road surface, and the map defining a relation between the third distance and the first reference velocity; and
compute the first reference velocity based on the third distance detected by the detection device and one of the plurality of maps.

6. The drive assist apparatus according to claim 1, wherein the electronic control unit is configured to control the host vehicle such that a velocity of the host vehicle running at a first velocity becomes the second reference velocity at the time when a first distance becomes a stop distance, the first distance being a distance between the host vehicle and the moving object in a traveling direction of the host vehicle, the stop distance being a shortest distance which the host vehicle running at the first velocity requires to stop.
